(19) United States
(12) Patent Application Publication
(10) Pub. No.: US 2014/0356661 A1
(43) Pub. Date: Dec. 4, 2014

(54) BATTERY MODULE ASSEMBLY AND ELECTRIC VEHICLE COMPRISING SAME

(71) Applicant: Gwang Ho Yang, Incheon (KR)

(72) Inventor: Gwang Ho Yang, Incheon (KR)

(73) Assignee: LG ELECTRONICS INC., Seoul (KR)

(21) Appl. No.: 14/365,964

(22) PCT Filed: Dec. 14, 2012
(86) PCT No.: PCT/KR2012/010947

§ 371 Date: Jun. 16, 2014

(30) Foreign Application Priority Data
Dec. 16, 2011 (KR) 10-2011-0136482

(51) Int. Cl. H01M 10/613; H01M 2/04

(52) U.S. Cl. CPC H01M 10/5004; H01M 2/0478
USPC 429/71; 429/72

(57) ABSTRACT

The present invention relates to a battery module assembly comprising: a plurality of unit cells; a central cartridge having a space for accommodating the plurality of unit cells; an upper cover for dissipating the heat from the uppermost unit cell among the plurality of unit cells; a lower cover for dissipating the heat from the lowermost unit cell among the plurality of unit cells; a first inner cover which contacts one of the plurality of intermediate unit cells between the uppermost unit cell and the lowermost unit cell; and a second inner cover which contacts another of the plurality of intermediate unit cells and forms an air passage between the first inner cover and the second inner cover. The central cartridge has a suction hole for suctioning air flowing along the air passage, and an exhaust hole for exhausting air flowing along the air passage. Thus, the battery module assembly of the present invention is advantageous in that heat dissipation for the plurality of intermediate unit cells between the uppermost unit cell and the lowermost unit cell can be performed by the air passing between the first inner cover and the second inner cover, and the plurality of intermediate unit cells can be protected by the first inner cover and the second inner cover.

### TECHNICAL FIELD

The present invention relates to a battery module assembly and an electric vehicle having the same, and more particularly, to a battery module assembly allowing a plurality of unit cells to dissipate heat and an electric vehicle having the same.

### BACKGROUND ART

Generally, a battery module assembly is installed at an electric vehicle or various portable devices to supply electric current.

The battery module assembly may be provided with a plurality of unit cells, and some of the unit cells may contact a cover forming the exterior of the battery module assembly, thereby dissipating heat through the cover.

The unit cells may be disposed in a stack, and at least one intermediate unit cell may be positioned between the uppermost unit cell and the lowermost unit cell.

### PRIOR ART DOCUMENT

Patent Document 001 10-0796097 B1 (Jan. 21, 2008).

### DISCLOSURE

### Technical Problem

In the case of a battery module according to the conventional art, if heat from plural intermediate unit cells positioned between the upper most unit cell and the lowermost unit cell fails to be dissipated, the intermediate unit cells may readily overheat, thereby lowering efficiency.

An object of the present invention is to provide a battery module assembly allowing heat from plural intermediate unit cells between the uppermost unit cell and the lowermost unit cell to be efficiently dissipated.

Another object of the present invention is to provide an electric vehicle allowing air to efficiently dissipate heat from the interior of a battery module assembly, thereby increasing performance and extending service life of the battery module assembly.

### Technical Solution

The object of the present invention can be achieved by providing a battery module assembly including a plurality of unit cells, a center cartridge having a space to accommodate the plurality of unit cells, an upper cover to dissipate heat from an uppermost unit cell of the plurality of unit cells, a lower cover to dissipate heat from a lowermost unit cell of the plurality of unit cells, a first inner cover to contact one of a plurality of intermediate unit cells between the uppermost unit cell and the lowermost unit cell, and a second inner cover to contact another one of the plurality of intermediate unit cells, an air passage being defined between the first inner cover and the second inner cover, wherein the center cartridge is provided with at least one suction hole allowing air to be suctioned into the air passage therethrough and at least one exhaust hole allowing the air to be discharged from the air passage therethrough.

In another aspect of the present invention, provided herein is an electric vehicle having at least one battery assembly module, including a vehicle body, a battery pack installed at the vehicle body and provided therein with at least one battery module assembly, the battery pack including an air suction hole allowing air for cooling of the battery module assembly to be introduced therethrough and an air discharge hole allowing the air having cooled the battery module assembly to be discharged therethrough, and an exhaust fan unit to suction the air through the air suction hole, cause the air to pass through the battery module assembly, and then blow the air to the air discharge hole, wherein the battery module assembly includes a plurality of unit cells, a center cartridge having a space to accommodate the plurality of unit cells, an upper cover to dissipate heat from an uppermost unit cell of the plurality of unit cells, a lower cover to dissipate heat from a lowermost unit cell of the plurality of unit cells, a first inner cover to contact one of a plurality of intermediate unit cells between the uppermost unit cell and the lowermost unit cell, and a second inner cover to contact another one of the plurality of intermediate unit cells, an air passage being defined between the first inner cover and the second inner cover, wherein the center cartridge is provided with at least one suction hole allowing air to be suctioned into the air passage therethrough and at least one exhaust hole allowing the air to be discharged from the air passage therethrough.

The suction hole and the exhaust hole may be formed to face the air passage.

The suction hole and the exhaust hole may be formed in the center cartridge to face each other in a front-to-back direction.

The suction hole and the exhaust hole may be formed between an upper end and lower end of the center cartridge to extend in a longitudinal direction of the center cartridge.

The at least one suction hole may include a plurality of suction holes spaced from each other in a longitudinal direction of the center cartridge, and the at least one exhaust hole may include a plurality of exhaust holes spaced from each other in the longitudinal direction of the center cartridge.

The first inner cover and the second inner cover may be formed of aluminum.

The first inner cover and the second inner cover may be thermally fused to the center cartridge.

Each of the first inner cover and the second inner cover may be provided with a seating groove allowing at least one part of the intermediate unit cells to be inserted thereinto to be seated.

The seating groove of one of the first inner cover and the second inner cover positioned at an upper side may have an open top, and the seating groove of the other one of the first inner cover and the second inner cover positioned at a lower side may have an open bottom.

The center cartridge may be provided with a spacing part to support the first inner cover and the second inner cover such that the first inner cover and the second inner cover are spaced from each other.

The spacing part may include an upper contact part protruding upward from the center cartridge, one of the first inner cover and the second inner cover positioned at an upper side contacting the upper contact part, and a lower contact part protruding downward from the center cartridge, the other one of the first inner cover and the second inner cover positioned at a lower side contacting the lower contact part.

Parts of the first inner cover and the second inner cover other than the seating grooves may contact the spacing part.

An expansion part may be formed at at least one of a front end of the suction hole and a rear end of the exhaust hole in a flow direction of air.

### Advantageous Effects

According to embodiments of the present invention, heat from a plurality of intermediate unit cells between the uppermost unit cell and the lowermost unit cell may be dissipated by air passing through a first inner cover and a second inner cover, and the intermediate unit cells may be protected by the first inner cover and the second inner cover.

### DESCRIPTION OF DRAWINGS

FIG. 1 is an exploded perspective view schematically illustrating an electric vehicle having a battery module assembly according to an exemplary embodiment of the present invention.

FIG. 2 is a transverse cross-sectional view illustrating main parts of an electric vehicle having a battery module assembly according to one embodiment of the present invention.

FIG. 3 is a perspective view illustrating a battery module assembly according to one embodiment of the present invention.

FIG. 4 is a rear view illustrating a battery module assembly according to one embodiment of the present invention.

FIG. 5 is an exploded perspective view illustrating a battery module assembly according to one embodiment of the present invention.

FIG. 6 is a cross-sectional view illustrating main parts of a battery module assembly according to one embodiment of the present invention.

FIG. 7 is a perspective view illustrating an inner cover of FIGS. 5 and 6 installed at a center cartridge.

### BEST MODE

Reference will now be made in detail to the exemplary embodiments of the present invention, examples of which are illustrated in the accompanying drawings.

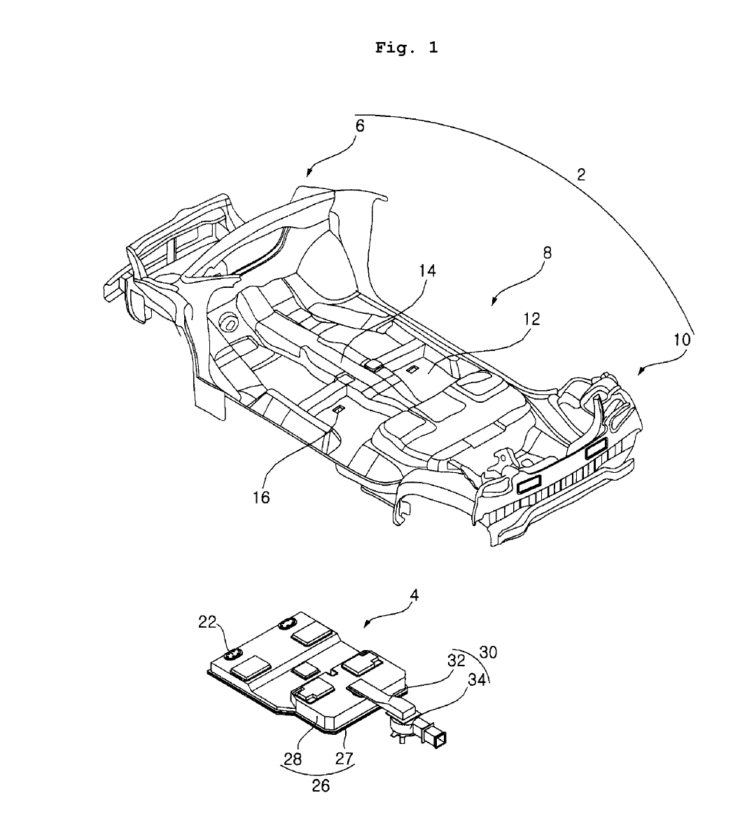

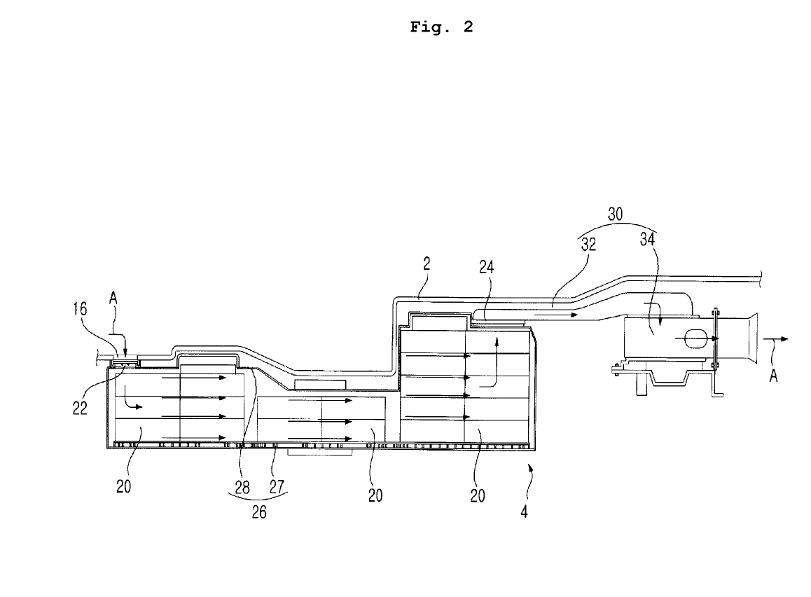

FIG. 1 is an exploded perspective view schematically illustrating an electric vehicle having a battery module assembly according to an exemplary embodiment of the present invention, and FIG. 2 is a transverse cross-sectional view illustrating main parts of an electric vehicle having a battery module assembly according to one embodiment of the present invention.

An electric vehicle having a battery module assembly may include a vehicle body 2 and a battery pack 4 installed in the vehicle body 2.

The vehicle body 2 may include a front vehicle body 6, a middle vehicle body 8 on which a person can ride and be seated, and a rear vehicle body 10 which can store a spare tire or other objects.

The vehicle body 2 may define a closed space, thereby allowing various devices to be disposed therein, accommodating passengers or goods, and facilitating entrance of passengers or goods and maintenance of various devices by opening a part. The shape of the vehicle body 2 may define the exterior of the vehicle.

The front vehicle body 6 may be provided with a motor and a power transmission component to transmit the driving power of the motor to the wheels of the vehicle. The motor may be connected to the wheel through the power transmission component and generate driving power to rotate the wheels.

The front vehicle body 6 may include a steering device to adjust orientation of the front wheels to change the travel direction of the electric vehicle, and a front wheel suspension to prevent vibration on the road surface from directly reaching the vehicle body. When the front vehicle body 6 is subjected to shock caused by, for example, an accident, it absorbs the shock by crumpling, thereby damping shock transferred to the interior of the vehicle.

Most parts of the middle vehicle body 8 are used as the interior of the vehicle, i.e., a place where passengers are seated, and thus the inner space of the middle vehicle body is designed to be as large as possible. The middle vehicle body 8 includes a floor 12 forming the bottom surface of the electric vehicle, and a central tunnel 14 formed at the center of the floor 12. The floor 12, which forms the bottom surface in the interior of the vehicle, is a panel having a wide area. The central tunnel 14 is fitted upward, and extends in the front-to-back direction. The central tunnel 14 may be integrated with the floor 12, or may be separately provided and connected through, for example, welding.

The rear vehicle body 10 may include a trunk to store a spare tire or other goods. The trunk may be connected with a trunk door to cover the trunk. The rear vehicle body 10 may be provided with a rear wheel suspension to prevent vibration from the road surface from directly reaching the vehicle body.

The battery pack 4 may be installed at at least one of the middle vehicle body 8 and rear vehicle body 10 of the vehicle body 2. The battery pack 4 may be installed at the lower side of the vehicle body 2. In a case in which the battery pack 4 is installed at the middle vehicle body 8 of the vehicle body 2, the battery pack 4 may be installed at the lower side of the middle vehicle body 8. In a case in which the battery pack 4 is installed at the rear vehicle body 10 of the vehicle body 2, the battery pack 4 may be installed at the lower side of the rear vehicle body 8 or the trunk.

The battery pack 4 may include at least one battery module assembly 20. The battery module assembly 20 may supply electric current necessary to drive the motor.

The battery pack 4 may be provided with an air suction hole 22, through which air A to cool the battery module assembly 20 is introduced, and an air discharge hole 24, through which the air A having cooled the battery module assembly 20 is discharged.

The battery pack 4 may include a battery case 26 to protect the battery module assembly 20, and the air suction hole 22 and the air discharge hole 24 may be formed in the battery case 26.

A plurality of battery module assemblies 20 may be stacked, and a plurality of groups of stacked battery module assemblies 20 may be disposed such that the groups are spaced in the front-to-back direction or in the lateral direction.

The battery case 26 may include a carrier 27 on which the plural battery module assemblies 20 are disposed, and a battery cover 28 coupled to the carrier 27 to define an accommodation space for the battery module assemblies 20 in conjunction with the carrier 27 and to protect the battery module assemblies 20.

In the battery pack 4, the carrier 27 may be fastened to the vehicle body 2 by a fastening member such as a bolt, and the battery cover 28 may be fastened to the carrier 27 by a fastening member such as a bolt.

The electric vehicle having the battery module assemblies may further include an exhaust fan unit 30.

The exhaust fan unit 30 may suction air through the air suction hole 22, cause the suctioned air to pass through the battery module assembly 20, and then send the air to the air discharge hole 24.

In the case of the electric vehicle having a battery module assembly according to this embodiment, the air in the interior of the vehicle may be suctioned through the air suction hole 22 of the battery pack 4, cool the battery module assemblies 20, and then be discharged outside through the air discharge hole 24 of the battery pack 4. The vehicle body 2 may be provided with a communication hole 16 communicating with the air suction hole 22 to allow the air in the interior of the vehicle to be suctioned into the air suction hole 22 of the battery pack 4.

The exhaust fan unit 30 may be installed at the interior of the vehicle, or may be installed between the interior of the vehicle and the battery pack 4, or may be installed at the battery pack 4. In the case in which the exhaust fan unit 30 is installed at the battery pack 4, the exhaust fan unit 30 may include an exhaust duct 32 communicating with the air discharge hole 24 and an air blower 34 connected to the exhaust duct 32. When the air blower 34 is driven, the air blower 34 may suction the air out of the battery pack 4 through the exhaust duct 32 and discharge the air into the atmosphere.

According to this embodiment, the electric vehicle having a battery module assembly may further include an air conditioner to adjust the interior temperature of the vehicle. The air cooled by the air conditioner may be suctioned into the air suction hole 22 of the battery pack 4, cooling the battery module assemblies 20 and then being discharged to the exterior through the air discharge hole 24 of the battery pack 4. The air conditioner may include a refrigeration cycle configured of a compressor, a condenser, an expansion mechanism, and an evaporator. The evaporator may include an interior-of-vehicle cooling evaporator to cool the interior of the vehicle, and a battery module assembly cooling evaporator to cool the battery module assemblies 20. The air conditioner may further include an evaporator fan which causes the air in the interior of the vehicle or the outdoor air to flow to the interior-of-vehicle cooling evaporator and then discharges the air to the interior of the vehicle. The exhaust fan unit 30 may cause the air in the interior of the vehicle or the outdoor air to flow to the battery module assembly cooling evaporator and cause the cooled air to pass through the interior of the battery pack 4 and then be discharged to the exterior. Thereby, the exhaust fan unit 30 may cool the battery module assemblies 20. In the case in which the air conditioner includes the battery module assembly cooling evaporator, the exhaust fan unit 30 may be installed between the battery module assembly cooling evaporator and the battery pack 4, or may be installed at the battery pack 4.

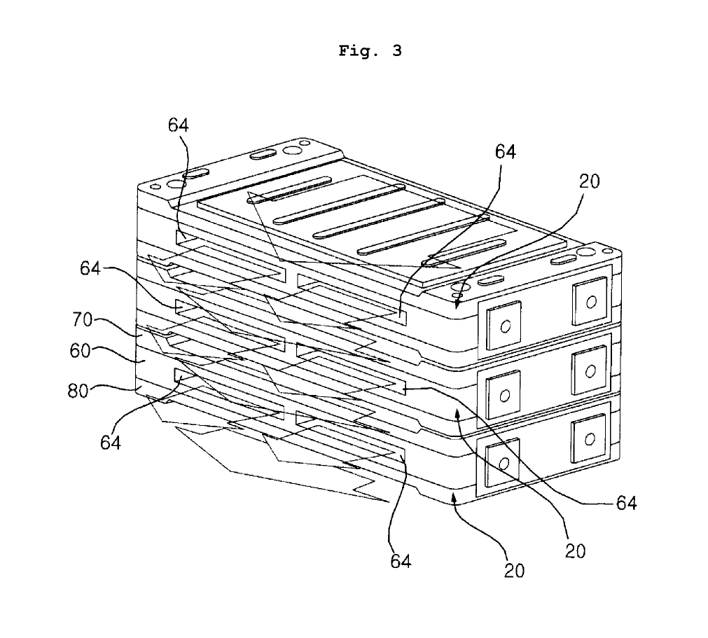

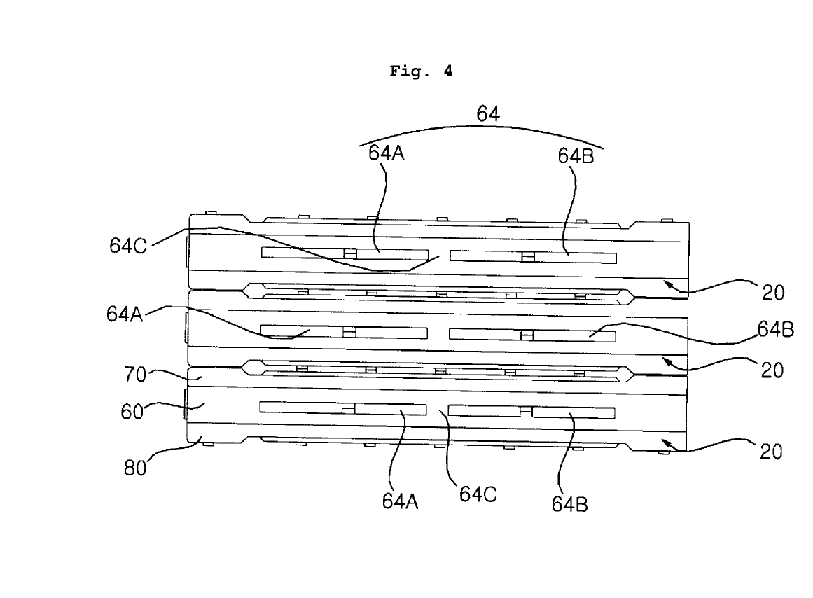

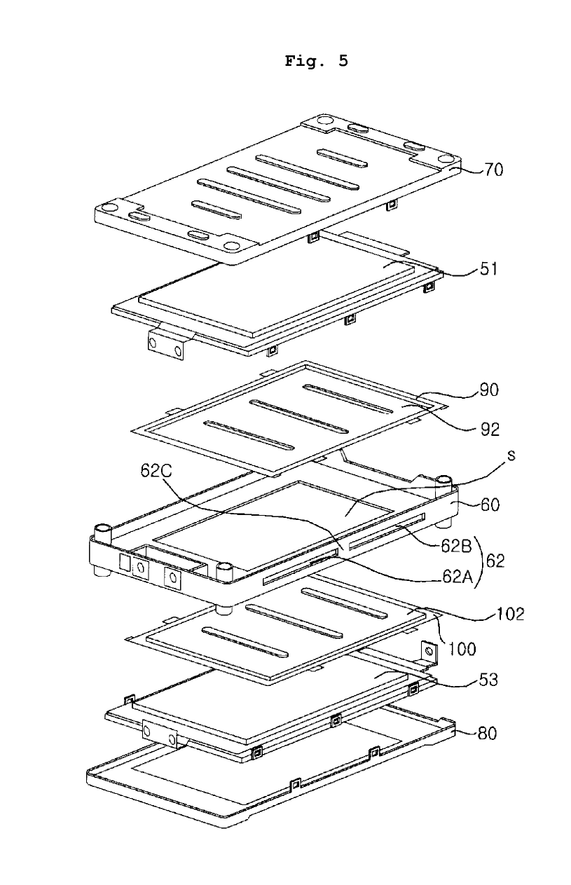

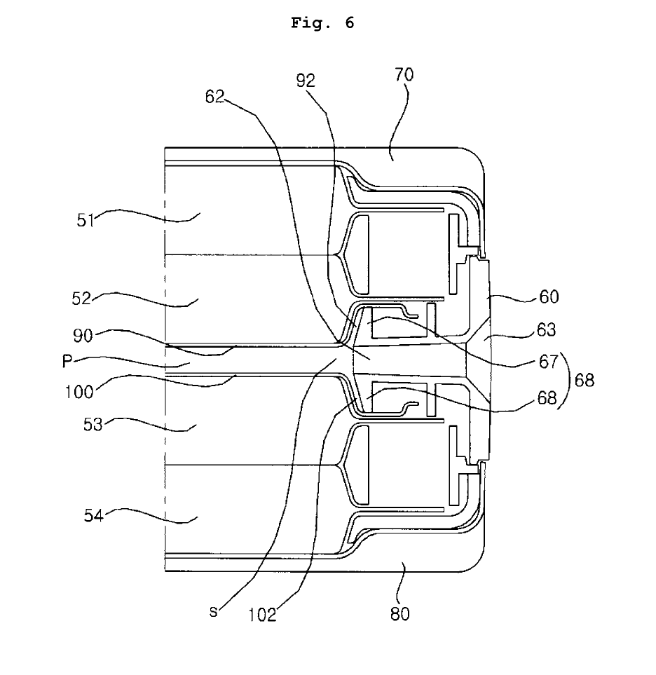

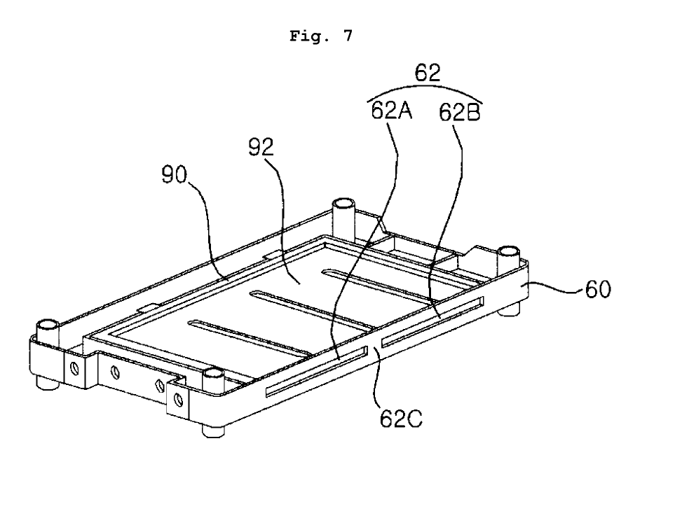

FIG. 3 is a perspective view illustrating a battery module assembly according to one embodiment of the present invention, FIG. 4 is a rear view illustrating a battery module assembly according to one embodiment of the present invention, and FIG. 5 is an exploded perspective view illustrating a battery module assembly according to one embodiment of the present invention. FIG. 6 is a cross-sectional view illustrating main parts of a battery module assembly according to one embodiment of the present invention, and FIG. 7 is a perspective view illustrating an inner cover of FIGS. 5 and 6 installed at a center cartridge.

The battery module assembly 20 of this embodiment may include a plurality of unit cells 51, 52, 53 and 54, a center cartridge 60 having a space S to accommodate the unit cells 51, 52, 53 and 54, an upper cover 70 to dissipate heat from an uppermost unit cell 51 of the unit cells 51, 52, 53 and 54, a lower cover 80 to dissipate heat from a lowermost unit cell 54 of the unit cells 51, 52, 53 and 54, a first inner cover 90 to contact one unit cell 52 of the intermediate unit cells 52 and 53 between the uppermost unit cell 51 and the lowermost unit cell 54, and a second inner cover 100 to contact the other unit cell 53 of the intermediate unit cells 52 and 53 and to form an air passage P defined between the first inner cover 90 and the second inner cover 100.

Each of the unit cells 51, 52, 53 and 54 may be provided with an electrode. The electrodes are unit cell leads which are respectively provided to the unit cells 51, 52, 53 and 54. Each electrode may be connected with a terminal. The terminal may receive current from the electrode. The terminal may be connected with an external device such as the motor by a high voltage cable.

Every two of the unit cells 51, 52, 53 and 54 may constitute a bundle. Thereby, plural bundles of the unit cells may be installed in one battery module assembly 20.

An even number of the unit cells 51, 52, 53 and 54 may be installed, and at least four unit cells may be installed.

The plurality of unit cells 51, 52, 53 and 54 may include four installed unit cells, which may be constituted by first, second, third and fourth unit cells 51, 52, 53 and 54. Hereinafter, it will be assumed four unit cells 51, 52, 53 and 54 are installed. However, the number of the unit cells is not limited thereto.

The first, second, third and fourth unit cells 51, 52, 53 and 54 may be vertically disposed. The first unit cell 51 may be the uppermost unit cell 51 positioned at the uppermost side, and the fourth unit cell 54 may be the lowermost unit cell 54 positioned at the lowermost side. The second unit cell and the third unit cell 53 may be the intermediate unit cells 52 and 53. The second unit cell 52 may be positioned between the first unit cell 51 and the third unit cell 53. The third unit cell 53 may be positioned between the second unit cell 52 and the fourth unit cell 54.

The first unit cell 51 and the second unit cell 52 may closely contact each other, and the third unit cell 53 and the fourth unit cell 54 may closely contact each other. A gap may be formed between the second unit cell 52 and the third unit cell 53. The gap between the second unit cells 4 and the third unit cells 6 may be formed by the center cartridge 60.

That is, the intermediate unit cell 52 positioned at the upper side relative to the other one of the intermediate unit cells 52 and 53 may closely contact the uppermost unit cell 51, and the intermediate unit cell 53 positioned at the lower side may closely contact the lowermost unit cell 54. The intermediate unit cells 52 and 53 may be spaced from each other.

The center cartridge 60 may be provided with a suction hole 62 allowing air to be suctioned into the air passage P therethrough and an exhaust hole 64 allowing the air to be discharged from the air passage P therethrough. The air may be suctioned into the center cartridge 60 through the suction hole 62, and be discharged from the center cartridge 60 through the exhaust hole 64.

The suction hole 62 and the exhaust hole 64 may be positioned in the center cartridge 60 so as to face the intermediate unit cells 52 and 53. Each of the suction hole 62 and the exhaust hole 64 may be formed to face the air passage P.

The suction hole 62 and the exhaust hole 64 may be formed to face the center cartridge 60. For example, if the suction hole 62 is formed in the front plate of the center cartridge 60 to be open in the front-to-back direction, the exhaust hole 64 may be formed in the rear plate of the center cartridge 60 to be open in the front-to-back direction. If the suction hole 62 is formed in the left plate of the center cartridge 60 to be open in the lateral direction, the exhaust hole 64 may be formed in the right plate of the center cartridge 60 to be open in the front-to-back direction.

Each of the suction hole 62 and the exhaust hole 64 may be formed between the upper end and lower end of the center cartridge 60 to extend in the longitudinal direction of the center cartridge 60. A plurality of suction holes 62 may be arranged spaced from each other in the longitudinal direction of the center cartridge 60, and a plurality of exhaust holes 64 may also be arranged spaced from each other in the longitudinal direction of the center cartridge 60. An expansion part 63 may be formed at at least one of the front end of the suction hole and the rear end of the exhaust hole 62 in the flow direction of air. The expansion part 63 may be formed at the front end of the suction hole 62 such that the area of the expansion part 63 increases as the expansion part 63 extends in the opposite direction of flow of air.

The suction hole 62 may include a first suction hole 62A and a second suction hole 62B spaced from the first suction hole 62A. A bridge 62C may be formed between the first suction hole 62A and the second suction hole 62B. Herein, the bridge 62C may enhance the strength of one of the front, rear, left and right plates of the center cartridge 60 which has the first suction hole 62A and the second suction hole 62B.

The exhaust hole 64 may include a first discharge hole 64A and a second discharge hole 64B spaced from the first discharge hole 64A. A bridge 64C may be formed between the first discharge hole 64A and the second discharge hole 64B. Herein, the bridge 62C may enhance the strength of one of the front, rear, left and right plates of the center cartridge 60, which includes the first discharge hole 64A and the second discharge hole 64B.

The first inner cover 90 and the second inner cover 100 may be disposed in the space S and function as a heat dissipation plates to dissipate the heat from the intermediate unit cells 52 and 53.

Preferably, each of the first inner cover 90 and the second inner cover 100 is formed of a metallic material exhibiting high thermal conductivity. The metallic material may include copper and aluminum.

Preferably, rocking or pushing of the first inner cover 90 and the second inner cover 100 by the air passing the air passage P is minimized, the first inner cover 90 and the second inner cover 100 may be formed of aluminum.

The first inner cover 90 and the second inner cover 100 and the center cartridge 60 may be thermally fused together. The edges of the first inner cover 90 and the second inner cover 100 may contact the center cartridge 60 and plural parts of the edges may be thermally fused to the center cartridge 60.

Each of the first inner cover 90 and the second inner cover 100 may be provided with a seating groove 92, 102 into which at least one portion of each of the intermediate unit cells 52 and 53 is inserted to be seated.

The seating groove 92 for one of the first inner cover 90 and the second inner cover 100 that is positioned at the upper side may have an open top.

The seating groove 100 for the other one of the first inner cover 90 and the second inner cover 100 which is positioned at the lower side may have an open bottom.

The center cartridge 60 may be provided with a spacing part 66 to support the first inner cover 90 and the second inner cover 100 such that the first inner cover 90 and the second inner cover 100 are spaced from each other. The spacing part 66 may include an upper contact part 67 protruding upward from the center cartridge 60 to contact one of the inner covers positioned at the upper side, and a lower contact part 68 protruding downward from the center cartridge 60 to contact the other one of the inner covers positioned at the upper side. The first inner cover 90 may be in full non-contact with the second inner cover 100. Other parts of the first inner cover 90 and the second inner cover 100 than the seating groves 92 and 102 may contact the spacing part 66.

Hereinafter, operation of the present invention will be described.

First, in driving the exhaust fan unit 30, the air in the interior of the vehicle or the air cooled by the air conditioner is suctioned through the air suction hole 22 and moved to the battery module assembly 20. Thereby, the air cools the battery module assembly 20 by contacting the battery module assembly 20.

The air having moved to the upper side of the battery module assembly 20 may absorb heat from the upper cover 70.

The air having moved to the lower side of the battery module assembly 20 may absorb heat from the lower cover 80.

In addition, the air having moved to the center cartridge 60 of the battery module assembly 20 is introduced into the battery module assembly 20 by passing through the suction hole 62 of the center cartridge 60. The air introduced into the battery module assembly 20 absorbs heat from the first inner cover 90 and the second inner cover 100, while passing through the space between the first inner cover 90 and the second inner cover 100. After absorbing heat from the first inner cover 90 and the second inner cover 100, the air is discharged from the battery module assembly 20 through the exhaust hole 64.

The first unit cell 51 of the battery module assembly 20 may dissipate heat to the upper cover 70, and the second unit cell 52 may dissipate heat to the first inner cover 90. The third unit cell 53 may dissipate heat to the second inner cover 100, and the fourth unit cell 54 may dissipate heat to the lower cover 80.

The air having absorbed the heat of the battery module assembly 20 may then be discharged through the air discharge hole 24.

1. A battery module assembly comprising:
a plurality of unit cells;
a center cartridge having a space to accommodate the plurality of unit cells;
an upper cover to dissipate heat from an uppermost unit cell of the plurality of unit cells;
a lower cover to dissipate heat from a lowermost unit cell of the plurality of unit cells;
a first inner cover to contact one of a plurality of intermediate unit cells between the uppermost unit cell and the lowermost unit cell; and
a second inner cover to contact another one of the plurality of intermediate unit cells, an air passage being defined between the first inner cover and the second inner cover,
wherein the center cartridge is provided with at least one suction hole allowing air to be suctioned into the air passage therethrough and at least one exhaust hole allowing the air to be discharged from the air passage therethrough.

2. The battery module assembly according to claim 1, the suction hole and the exhaust hole are formed to face each other.

3. The battery module assembly according to claim 1, wherein each of the suction hole and the exhaust hole is formed between an upper end and lower end of the center cartridge to extend in a longitudinal direction of the center cartridge.

4. The battery module assembly according to claim 1, wherein the at least one suction hole comprises a plurality of suction holes spaced from each other in a longitudinal direction of the center cartridge, and the at least one exhaust hole comprises a plurality of exhaust holes spaced from each other in the longitudinal direction of the center cartridge.

5. The battery module assembly according to claim 1, wherein the first inner cover and the second inner cover are formed of aluminum.

6. The battery module assembly according to claim 1, wherein the first inner cover and the second inner cover are thermally fused to the center cartridge.

7. The battery module assembly according to claim 1, wherein each of the first inner cover and the second inner cover is provided with a seating groove allowing at least one part of the intermediate unit cells to be inserted thereinto to be seated.

8. An electric vehicle having at least one battery module assembly, comprising:
a vehicle body;
a battery pack installed at the vehicle body and provided therein with the at least one battery module assembly, the battery pack comprising an air suction hole allowing air for cooling of the battery module assembly to be introduced therethrough and an air discharge hole allowing the air having cooled the battery module assembly to be discharged therethrough; and
an exhaust fan unit to suction the air through the air suction hole, cause the air to pass through the battery module assembly, and then blow the air to the air discharge hole,
wherein the battery module assembly comprises:
a plurality of unit cells;
a center cartridge having a space to accommodate the plurality of unit cells;
an upper cover to dissipate heat from an uppermost unit cell of the plurality of unit cells;
a lower cover to dissipate heat from a lowermost unit cell of the plurality of unit cells;
a first inner cover to contact one of a plurality of intermediate unit cells between the uppermost unit cell and the lowermost unit cell; and
a second inner cover to contact another one of the plurality of intermediate unit cells, an air passage being defined between the first inner cover and the second inner cover,
wherein the center cartridge is provided with at least one suction hole allowing air to be suctioned into the air passage therethrough and at least one exhaust hole allowing the air to be discharged from the air passage therethrough.

9. The electric vehicle according to claim 8, wherein the suction hole and the exhaust hole are formed to face the air passage.

10. The electric vehicle according to claim 8, wherein the suction hole and the exhaust hole are formed in the center cartridge to face each other in a front-to-back direction.

11. The electric vehicle according to claim 8, wherein the suction hole and the exhaust hole are formed between an upper end and lower end of the center cartridge to extend in a longitudinal direction of the center cartridge.

12. The electric vehicle according to claim 8, wherein the at least one suction hole comprises a plurality of suction holes spaced from each other in a longitudinal direction of the center cartridge, and the at least one exhaust hole comprises a plurality of exhaust holes spaced from each other in the longitudinal direction of the center cartridge.

13. The electric vehicle according to claim 8, wherein the first inner cover and the second inner cover are formed of aluminum.

14. The electric vehicle according to claim 8, wherein the first inner cover and the second inner cover are thermally fused to the center cartridge.

15. The electric vehicle according to claim 8, wherein each of the first inner cover and the second inner cover is provided with a seating groove allowing at least one part of the intermediate unit cells to be inserted thereinto to be seated.

16. The electric vehicle according to claim 15, wherein:
the seating groove of one of the first inner cover and the second inner cover positioned at an upper side has an open top; and
the seating groove of the other one of the first inner cover and the second inner cover positioned at a lower side has an open bottom.

17. The electric vehicle according to claim 15, wherein the center cartridge is provided with a spacing part to support the first inner cover and the second inner cover such that the first inner cover and the second inner cover are spaced from each other.

18. The electric vehicle according to claim 17, wherein the spacing part comprises:
an upper contact part protruding upward from the center cartridge, one of the first inner cover and the second inner cover positioned at an upper side contacting the upper contact part; and
a lower contact part protruding downward from the center cartridge, the other one of the first inner cover and the second inner cover positioned at a lower side contacting the lower contact part.

19. The electric vehicle according to claim 17, wherein parts of the first inner cover and the second inner cover other than the seating grooves contact the spacing part.

20. The electric vehicle according to claim 8, wherein an expansion part is formed at at least one of a front end of the suction hole and a rear end of the exhaust hole in a flow direction of air.
